(19) United States
(12) Patent Application Publication
(10) Pub. No.: US 2012/0051174 A1
(43) Pub. Date: Mar. 1, 2012

(54) NATURAL MILK BASED FOOD COMPOSITION, PROCESS AND DEVICE FOR DYNAMIC PREPARATION

(76) Inventors: Gabreal Livschits, San Francisco, CA (US); Gennadiy Flider, San Francisco, CA (US)

(21) Appl. No.: 13/114,025

(22) Filed: May 23, 2011

Related U.S. Application Data
(60) Provisional application No. 61/347,436, filed on May 23, 2010.

(51) Int. Cl. A01J 15/08

(52) U.S. Cl. 366/187; 366/213; 366/209

(57) ABSTRACT

In some aspects, an apparatus and method churning butter out of multi-component raw material are provided. The movement of the raw material develops energy that churns the raw material into butter.

### REFERENCE TO RELATED APPLICATION

This application claims the priority benefit under 35 U.S.C. §119(e) of U.S. Provisional Application No. 61/347,436, filed May 23, 2010, the entire disclosure of which is incorporated herein by reference.

### TECHNICAL FIELD

The invention relates to composite food products, such as dairy food compositions and dynamically mixed products, and processes employed in producing them. In some embodiments, the natural milk based food composition process, dynamic activation method and device relate to the field of butter churning and particularly to a method of churning butter out of a mass of multi-component raw material containing components of both vegetable and animal origin.

### BACKGROUND

Butter is a widely used food product typically industrially produced from the fat of the milk and sweet or soured cream. At the end of the process, different food additives and tastes may be added to the just produced butter. Sweet and salted butters are known. Chocolate flowered butter is known. It is difficult to answer a variety of consumer tastes using industrial manufacturing methods, and home butter churning appliances are gaining popularity.

Accordingly, there is a need in a simple, easy to use butter-churning appliance that allows butter making and the addition of different taste and food value enhancing ingredients and materials.

### SUMMARY OF THE INVENTION

Natural milk based food composition, including a matrix, in which cavitation breaks contain capsulated fillers of compositions, and the matrix mainly includes dairy-sour fatty components which material is an environment of capsules fillers compositions, and in boundary layers between capsules and a matrix contains emulsion from base materials of fillers compositions in which materials of a matrix in the form of micro-droplets are introduced.

Natural milk based food composition, including a spatial matrix, in which cavitation breaks contain capsulated fillers compositions, and the matrix mainly includes dairy-sour fatty components which material is also an environment of capsules of fillers compositions, and in boundary layers between capsules and a matrix contains emulsion from base materials of fillers compositions in which materials of a matrix in the form of micro-droplets, having the developed internal three-dimensional structure are introduced.

Natural milk based food composition, including a matrix, in which cavitation breaks contain capsulated fillers of compositions, and the matrix mainly includes dairy-sour fatty components which material is an environment of capsules of fillers of compositions, and in boundary layers between capsules and a matrix contains emulsion from base materials of the fillers of compositions in which materials of a matrix and in which are introduced, insoluble in materials of fillers of compositions, materials of a matrix in the form of micro-droplets are dissolved.

Process for dynamic preparation of natural milk food composition including consecutive loading in the closed container of components of natural milk food composition, formation symmetric concerning an axis of rotation of the container of pulsations of the weight of the specified components integrated by it with cyclic change of a vector of a direction of movement of weight of the specified liquid components of natural milk food composition, on, at least, 180 degrees, at amplitude of the specified pulsations equal to distance between end faces of the cylinder of the container.

Device for dynamic preparation of natural milk based food composition, including a system of the kinematic elements having the general mechanism for formation of pulsations of weight of components of natural milk food composition with cyclic change of a vector of a direction of movement of weight of specified components on, at least, 180 degrees in which the specified weight of components of natural milk food composition is concentrated in the container of the cylindrical form with the fixed end faces, one of which is placed in slide block which has an opportunity to move and be fixed in a rotating bearing base ring of a drive of rotation of the specified container, and the second end face has communication with the press fixing mechanism which axis is located in a radial direction in relation to a bearing base ring and has an opportunity of angular moving concerning the center of a specified ring, But also in each cyclic change of position of weight of components of natural milk food composition in the cylinder, at the bottom arrangement of the press fixing mechanism, the top level of weight of components in each such cyclic change of position is located below a point of crossing of a horizontal axis of rotation of a rotating bearing base ring and a linear axis of the cylinder of the container.

Process for dynamic preparation of food composition, including consecutive loading in the closed container of components of food composition, formation symmetric concerning an axis of rotation of the container of pulsations of the weight of the specified components integrated by it with cyclic change of a vector of a direction of movement of weight of the specified liquid components of food composition, on, at least, 180 degrees, at amplitude of the specified pulsations equal to distance between end faces of the cylinder of the container.

Device for dynamic preparation of food composition, including a system of the kinematic elements having the general mechanism for formation of pulsations of weight of components of a food composition with cyclic change of a vector of a direction of movement of weight of specified components on, at least, 180 degrees in which the specified weight of components of a food composition is concentrated in the container of the cylindrical form with the fixed end faces, one of which is placed in slide block which has an opportunity to move and be fixed in a rotating bearing base ring of a drive of rotation of the specified container, and the second end face has communication with the press fixing mechanism which axis is located in a radial direction in relation to a bearing base ring and has an opportunity of angular moving concerning the center of the specified ring, but also in each cyclic change of position of weight of components of a food composition in the cylinder, At the bottom arrangement of the press fixing mechanism, the top level of weight of components in each such cyclic change of position is located below a point of crossing of a horizontal axis of rotation of a rotating bearing base ring and a linear axis of the cylinder of the container.

Process for dynamic preparation of fluids composition, including consecutive loading in the closed container of components of fluids composition, formation symmetric concerning an axis of rotation of the container of pulsations of the weight of the specified components integrated by it with cyclic change of a vector of a direction of movement of weight of the specified liquid components of fluids composition, on, at least, 180 degrees, at amplitude of the specified pulsations equal to distance between end faces of the cylinder of the container.

Device for dynamic preparation of fluids composition, including a system of the kinematic elements having the general mechanism for formation of pulsations of weight of components of a liquid composition with cyclic change of a vector of a direction of movement of weight of specified liquid components of a composition on, at least, 180 degrees in which the specified weight of components of a liquid composition is concentrated in the container of the cylindrical form with the fixed end faces, one of which is placed in slide block which has an opportunity to move and be fixed in a rotating bearing base ring of a drive of rotation of the specified container, and the second end face has communication with the press fixing mechanism which axis is located in a radial direction in relation to a bearing base ring and has an opportunity of angular moving concerning the center of the specified ring, but also in each cyclic change of position of weight of components of a liquid composition in the cylinder, At the bottom arrangement of the press fixing mechanism, the top level of weight of components in each such cyclic change of position, is located below a point of crossing of a horizontal axis of rotation of a rotating bearing base ring and a linear axis of the cylinder of the container.

Process for dynamic preparation of fluids and solids composition, including consecutive loading in the closed container of components of fluids and solids composition, formation symmetric concerning an axis of rotation of the container of pulsations of the weight of the specified components integrated by it with cyclic change of a vector of a direction of movement of weight of the specified liquid components of fluids and solids composition, on, at least, 180 degrees, at amplitude of the specified pulsations equal to distance between end faces of the cylinder of the container.

Device for dynamic preparation of fluids and solids composition including a system of the kinematic elements having the general mechanism for formation of pulsations of weight of components of fluids and solids composition with cyclic change of a vector of a direction of movement of weight of specified components on, at least, 180 degrees in which the specified weight of components of fluids and solids composition is concentrated in the container of the cylindrical form with the fixed end faces, one of which is placed in slide block which has an opportunity to move and be fixed in a rotating bearing base ring of a drive of rotation of the specified container, and the second end face has communication with the press fixing mechanism which axis is located in a radial direction in relation to a bearing base ring and has an opportunity of angular moving concerning the center of the specified ring, but also in each cyclic change of position of weight of components of fluids and solids composition in the cylinder, At the bottom arrangement of the press fixing mechanism, the top level of weight of components in each such cyclic change of position is located below a point of crossing of a horizontal axis of rotation of a rotating bearing base ring and a linear axis of the cylinder of the container.

### BRIEF DESCRIPTION OF DRAWINGS

Various attributes of the present invention are illustrated by graphic materials and drawings where on figures of drawings variants of examples of embodiments of the present invention are presented;

FIG. 1,—on a figure the device for reception of a food composition in the form of three-dimensional model is presented; a kind from a drive of rotation of a working shaft of the device

FIG. 2,—on a figure the device for reception of a food composition in the form of three-dimensional model is presented; a kind from opposite to a drive of rotation of a working shaft of the device

FIG. 3A,—on a figure the face-to-face projection of the device with a designation of all dimensional dependences between axes of shaft and critical points of the container with initial products for manufacture of a food composition is shown

FIG. 3 B,—on a figure the face-to-face projection of the device with a designation of all dimensional dependences between axes of shaft and critical points of the container with initial products for manufacture of a food composition is shown, at the top position of the mechanism of a clip and fixing of the container

FIG. 3 C,—on a figure the face-to-face projection of the device with a designation of all dimensional dependences between axes of shaft and critical points of the container with initial products for manufacture of a food composition is shown, at the bottom position of the mechanism of a clip and fixing of the container

FIG. 3D,—on a figure the face-to-face projection of the device with a designation of all dimensional dependences between axes of shaft and critical points of the container with initial products for manufacture of a food composition with the indication of a force vector of kinetic energy from weight of initial products is shown at the top position of the mechanism of a clip and fixing of the container

FIG. 3E,—on a figure the face-to-face projection of the device with a designation of all dimensional dependences between axes of shaft and critical points of the container with initial products for manufacture of a food composition with the indication of a force vector of kinetic energy from weight of initial products is shown at the bottom position of the mechanism of a clip and fixing of the container

FIG. 4A,—on a figure the face-to-face projection of the device with a designation of all dimensional dependences between axes of shaft and critical points of the container with initial products for manufacture of a food composition is shown at application in the container of an activating conic spring which top of a cone is directed aside the mechanism of a clip and fixing of the container

FIG. 4B,—on a figure the face-to-face projection of the device with a designation of all dimensional dependences between axes of shaft and critical points of the container with initial products for manufacture of a food composition is shown at application in the container of an activating flat step and conic spring on a structure which top of a cone is directed aside the mechanism of a clip and fixing of the container

FIG. 4C,—on a figure the face-to-face projection of the device with a designation of all dimensional dependences between axes of shaft and critical points of the container with initial products for manufacture of a food composition is shown

FIG. 4D,—on a figure the face-to-face projection of the device with a designation of all dimensional dependences between axes of shaft and critical points of the container with initial products for manufacture of a food composition is shown

FIG. 5A,—on a figure the face-to-face projection of the device with a designation of all dimensional dependences between axes of shaft and critical points of the container with initial products for manufacture of a food composition is shown, at the bottom position of the mechanism of a clip and fixing of the container

FIG. 5B,—on a figure the face-to-face projection of the device with a designation of all dimensional dependences between axes of shaft and critical points of the container with initial products for manufacture of a food composition is shown, at the top position of the mechanism of a clip and fixing of the container

FIG. 5C,—on a figure the face-to-face projection of the device with a designation of all dimensional dependences between axes of shaft and critical points of the container with initial products for manufacture of a food composition is shown, at the bottom position of the mechanism of a clip and fixing of the container

### DETAILED DESCRIPTION

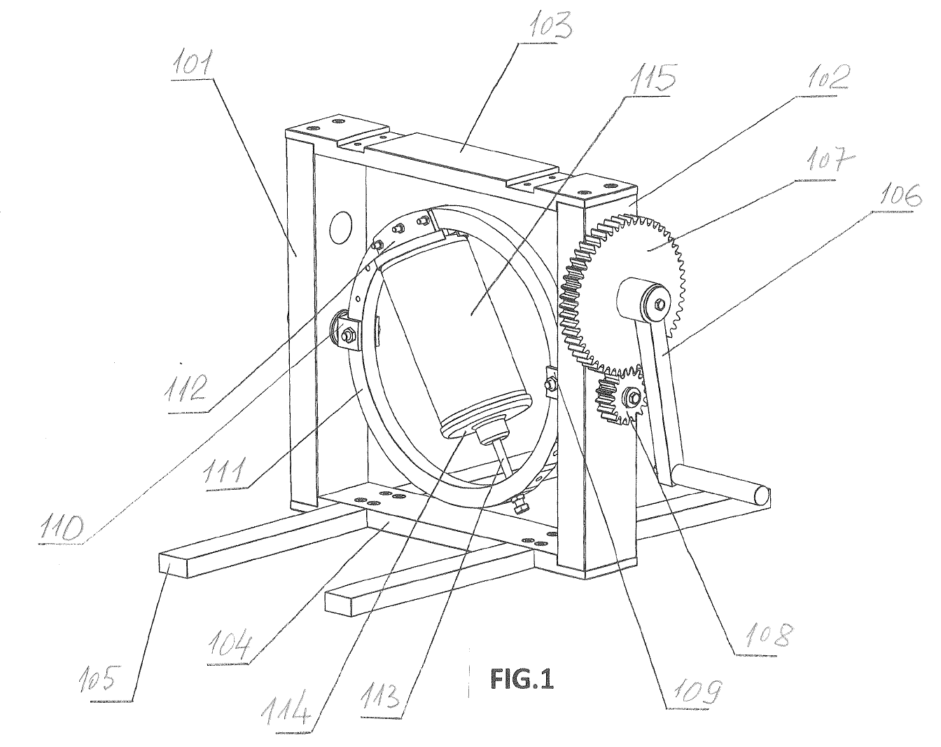

FIG. 1,—on a figure the device for reception of a food composition in the form of three-dimensional model is presented; a kind from a drive of rotation of a working shaft of the device; the container for knocking down of components of a product is at the bottom position of its screw mechanism of a clip and fixing; the drive of rotation of the container is based on a tooth gearing with transfer number 3:1;

By figures on a figure are designated:
101,—a passive rack of a framework of the bearing and base case of the device for dynamic reception of a food composition
102,—an active rack of a framework of the bearing and base case of the device for dynamic reception of a food composition
103,—the top rod of a framework of the bearing and base case of the device for dynamic reception of a food composition
104,—the bottom basic rod of a framework of the bearing and base case of the device for dynamic reception of a food composition
105,—additional basic rods of a framework of the bearing and base case of the device for dynamic reception of a food composition
106,—the lever with the handle for manual rotation of a drive of the device for dynamic reception of a food composition
107,—a leading cogwheel of a drive of the device for dynamic reception of a food composition
108,—a conducted cogwheel of a drive of the device for dynamic reception of a food composition
109,—a leading plug of a drive of rotation of the container of the device for dynamic reception of a food composition
110,—a conducted plug of a drive of rotation of the container of the device for dynamic reception of a food composition
111,—a rotating bearing base ring of a drive of rotation of the container of the device for dynamic reception of a food composition
112,—a basic element for installation of the container of the device for dynamic reception of a food composition
113,—the fixing, focusing and clamping screw of a drive of rotation of the container of the device for dynamic reception of a food composition
114,—a press cover of a drive of rotation of the container of the device for dynamic reception of a food composition
115,—the container of the device for dynamic reception of a food composition

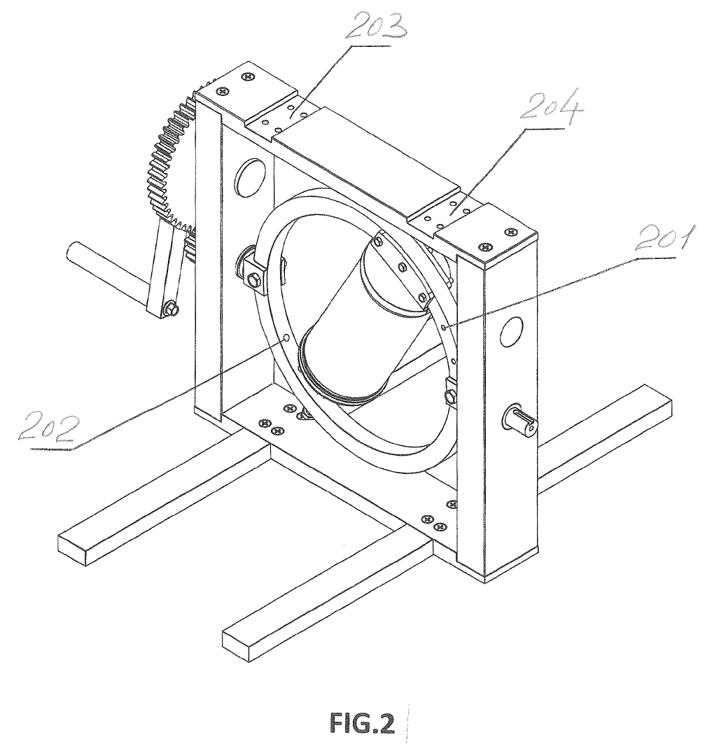

FIG. 2,—on a figure the device for reception of a food composition in the form of three-dimensional model is presented; a kind from opposite to a drive of rotation of a working shaft of the device; on a figure the auxiliary elements intended for adjustment, fixing and change of position of the container of the device for dynamic reception of a food composition are shown

By figures on a figure are designated:
201,—apertures for radial and angular orientation and fixation of the container for knocking down of components of a product on a rotating bearing base ring of a drive of rotation of the container of the device for dynamic reception of a food composition
202,—apertures for radial, circular and angular orientation and fixation of the container for knocking down of components of a product on a rotating bearing base ring of a drive of rotation of the container of the device for dynamic reception of a food composition
203,—grooves with apertures for fastening protective elements of a design of the device (on a figure are not shown);
204,—grooves with apertures for fastening protective elements of a design of the device (on a figure are not shown);

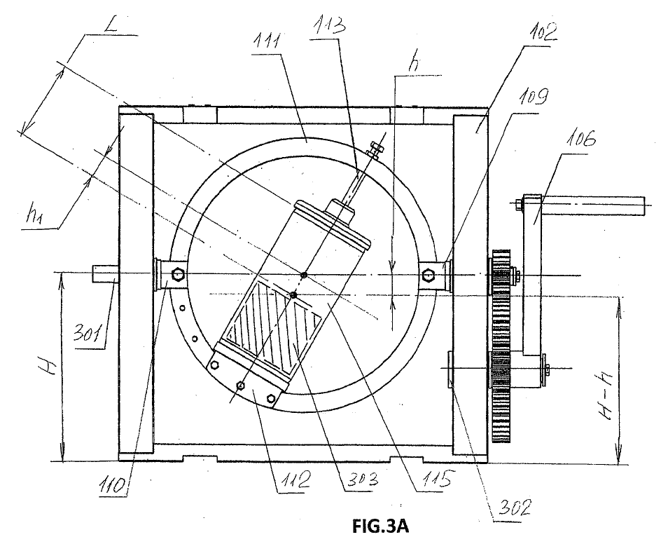

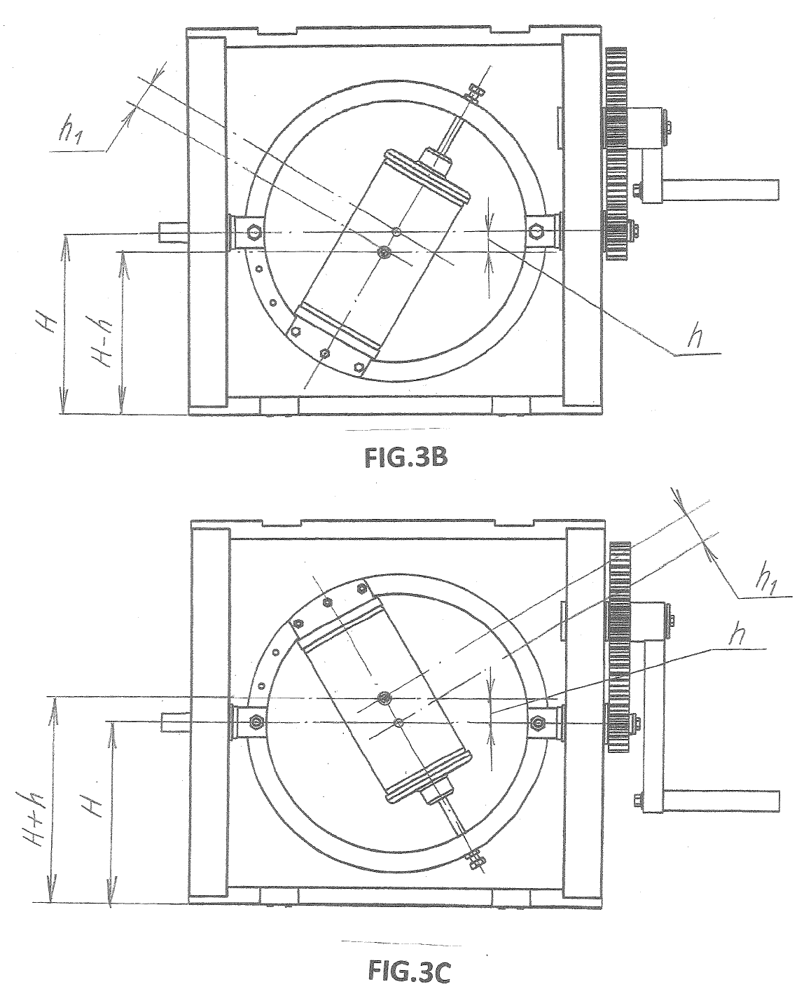

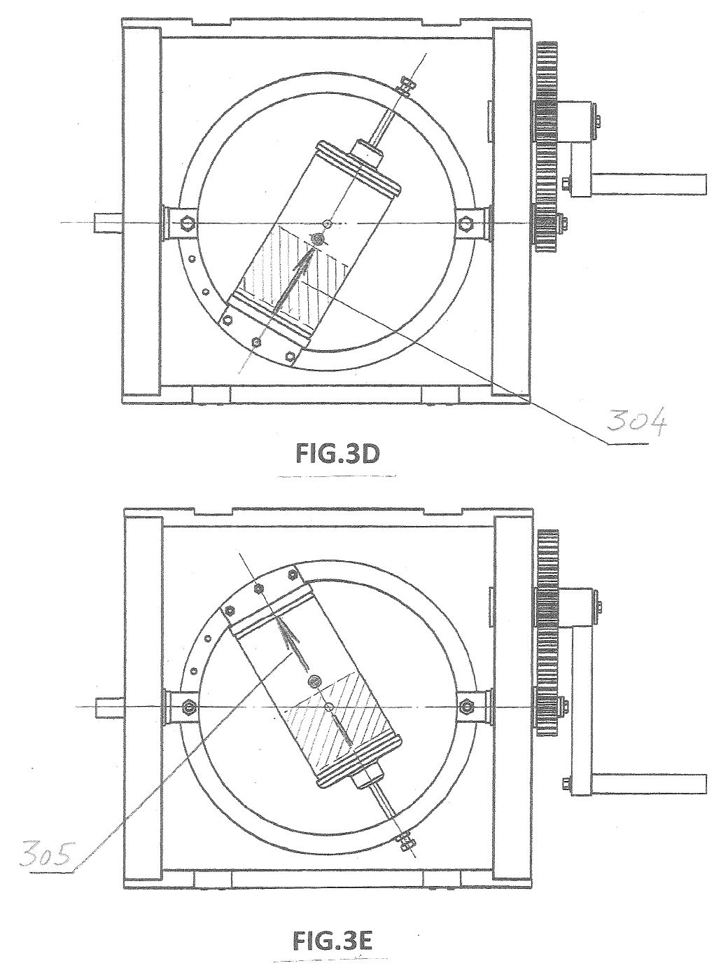

FIG. 3A,—on a figure the face-to-face projection of the device with a designation of all dimensional dependences between axes of shaft and critical points of the container with initial products for manufacture of a food composition is shown

By figures and symbols on a figure are designated:
301,—a conducted plug of a drive of rotation of the container of the device for dynamic reception of a food composition with continuation of the cylindrical basic axis intended for installation of possible additional elements
302,—a leading shaft of a drive of rotation of the container
303,—a symbol of an initial material in the container
H,—height of an axis of rotation of the container
h,—relative distance between the linear center of symmetry of the container and a point of crossing of a linear axis of the container with an axis of rotation of the container in the form of a projection of these points to a vertical coordinate axis
h1,—real distance between the linear center of symmetry of the container and a point of crossing of a linear axis of the container with an axis of rotation of the container
L,—size of a course of a material inside of the container at its turn on 180 degrees
H-h,—distance from the basis of the device up to the linear center of symmetry of the container

FIG. 3 B,—on a figure the face-to-face projection of the device with a designation of all dimensional dependences between axes of shaft and critical points of the container with initial products for manufacture of a food composition is shown, at the top position of the mechanism of a clip and fixing of the container

By figures on a figure are designated:
H-h,—distance from the basis of the device up to the linear center of symmetry of the container at the top position of the mechanism of a clip and fixing of the container

FIG. 3 C,—on a figure the face-to-face projection of the device with a designation of all dimensional dependences between axes of shaft and critical points of the container with initial products for manufacture of a food composition is shown, at the bottom position of the mechanism of a clip and fixing of the container
H+h,—distance from the basis of the device up to the linear center of symmetry of the container at the bottom position of the mechanism of a clip and fixing of the container

FIG. 3D,—on a figure the face-to-face projection of the device with a designation of all dimensional dependences between axes of shaft and critical points of the container with initial products for manufacture of a food composition with the indication of a force vector of kinetic energy from weight of initial products is shown at the top position of the mechanism of a clip and fixing of the container

By figures on a figure are designated:
304,—an integrated vector of forcing down effort and weights of a forced down material during the moment when the mechanism of a clip and fixing of the container is in the top position

FIG. 3E,—on a figure the face-to-face projection of the device with a designation of all dimensional dependences between axes of shaft and critical points of the container with initial products for manufacture of a food composition with the indication of a force vector of kinetic energy from weight of initial products is shown at the bottom position of the mechanism of a clip and fixing of the container

By figures on a figure are designated:
305,—an integrated vector of forcing down effort and weights of a forced down material during the moment when the mechanism of a clip and fixing of the container is in the bottom position

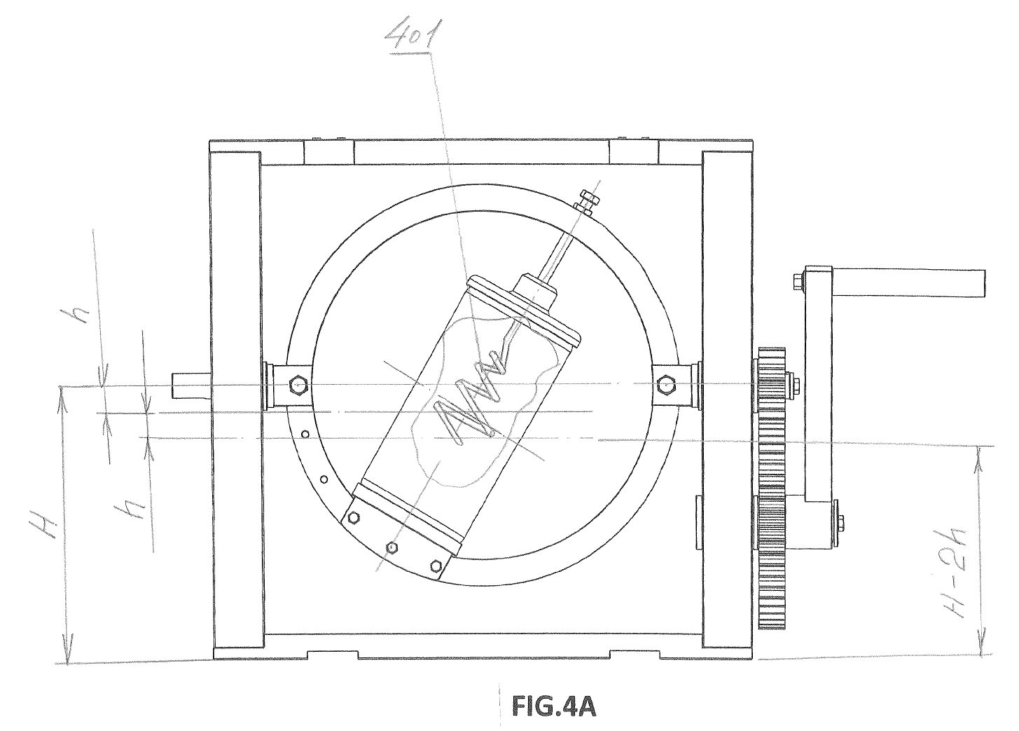

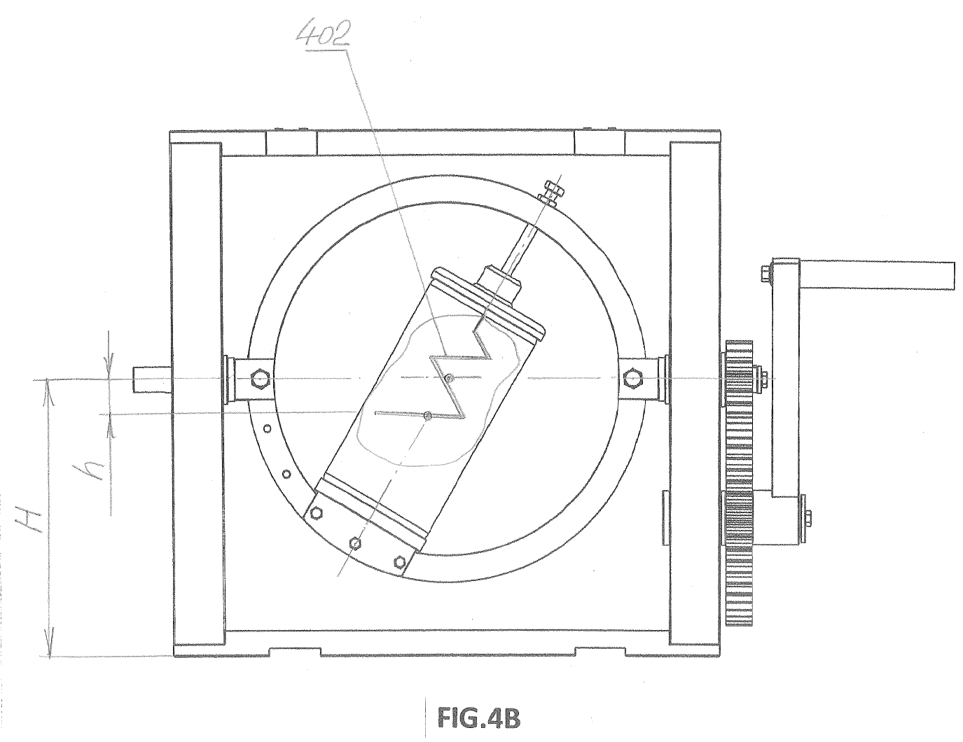

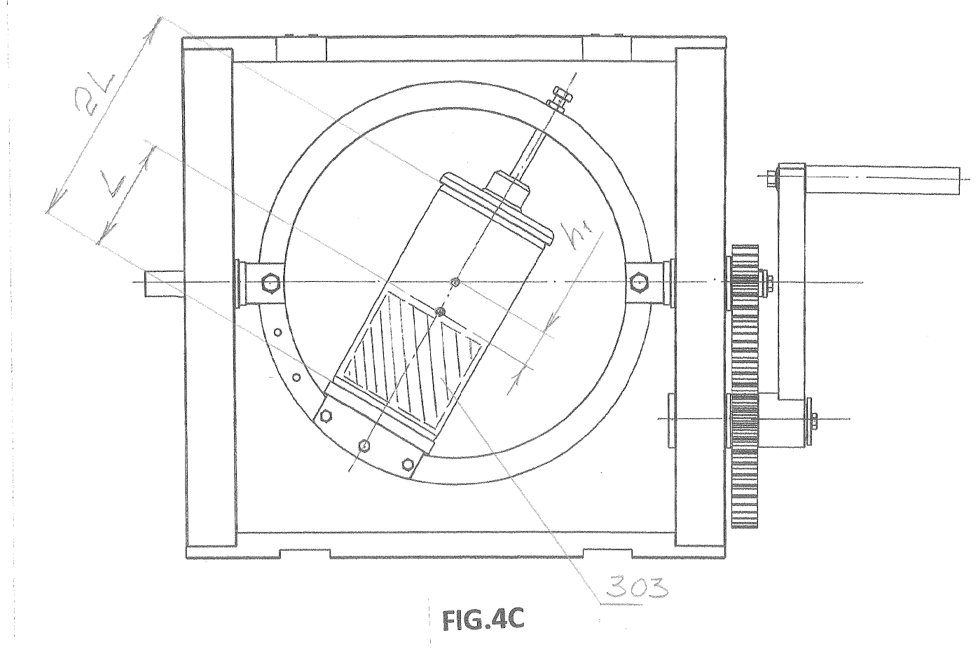

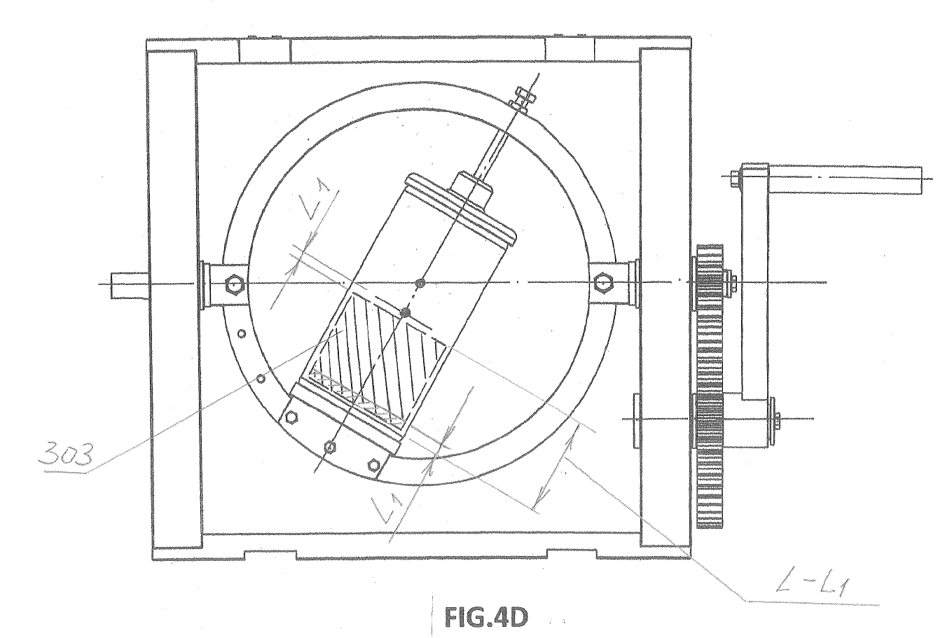

FIG. 4A,—on a figure the face-to-face projection of the device with a designation of all dimensional dependences between axes of shaft and critical points of the container with initial products for manufacture of a food composition is shown at application in the container of an activating conic spring which top of a cone is directed aside the mechanism of a clip and fixing of the container

By figures and symbols on a figure are designated:
401,—the activating conic spring, which top of a cone is directed aside the mechanism of a clip and fixing of the container
H-2h,—distance between the basis of the device and the bottom point of an activating conic spring which top of a cone is directed aside the mechanism of a clip and fixing of the container

FIG. 4B,—on a figure the face-to-face projection of the device with a designation of all dimensional dependences between axes of shaft and critical points of the container with initial products for manufacture of a food composition is shown at application in the container of an activating flat step and conic spring on a structure which top of a cone is directed aside the mechanism of a clip and fixing of the container

By figures on a figure are designated:
402,—an activating flat step and conic spring on a structure which top of a cone is directed aside the mechanism of a clip and fixing of the container

FIG. 4C,—on a figure the face-to-face projection of the device with a designation of all dimensional dependences between axes of shaft and critical points of the container with initial products for manufacture of a food composition is shown

By figures and symbols on a figure are designated:
L,—distance from the bottom of the container up to its linear center of symmetry
2L,—linear length of the container with initial products for manufacture of a food composition

FIG. 4D,—on a figure the face-to-face projection of the device with a designation of all dimensional dependences between axes of shaft and critical points of the container with initial products for manufacture of a food composition is shown

By figures and symbols on a figure are designated:
L1,—distance from top level of initial products in the container up to the linear center of symmetry of the container equal to distance between a bottom of the container up to the bottom level of initial products in the container which is filled by additional components of the initial products, not being dairy
L-L1,—distance from bottom of the container up to top level of initial products in the container

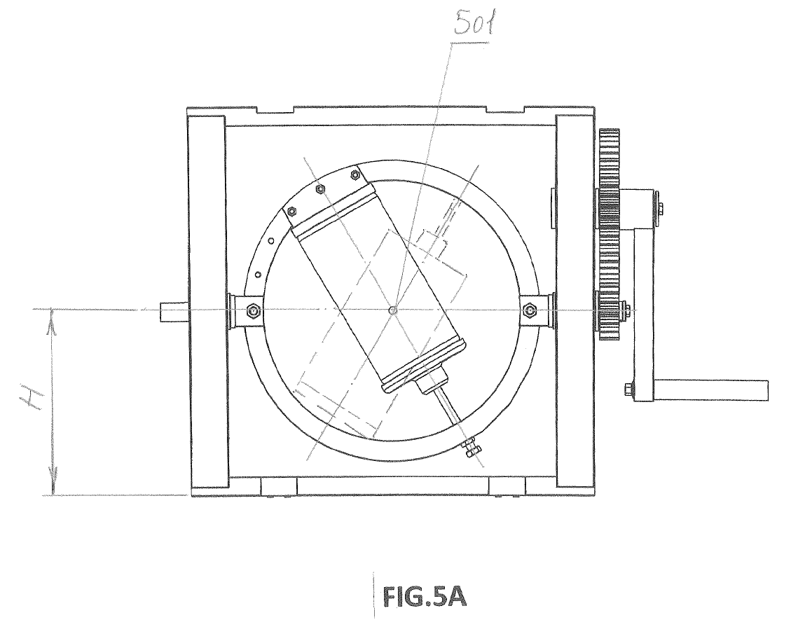

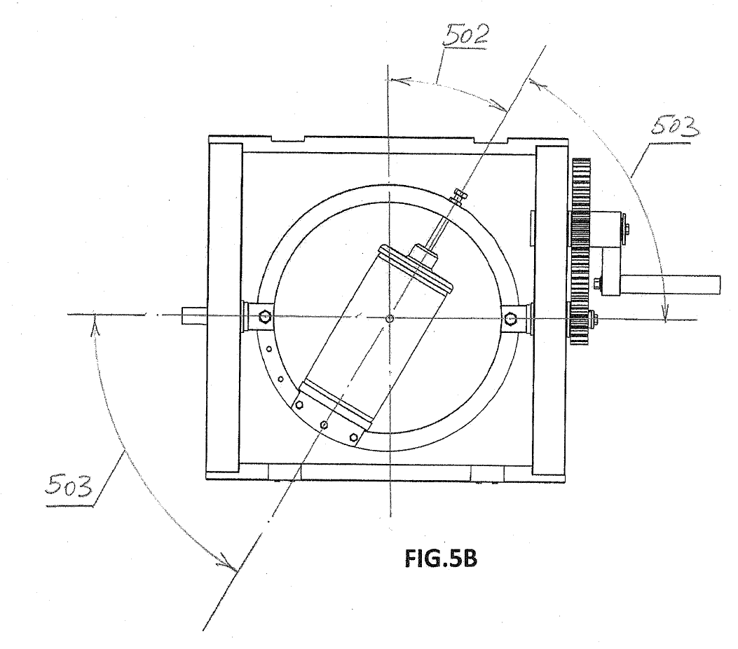

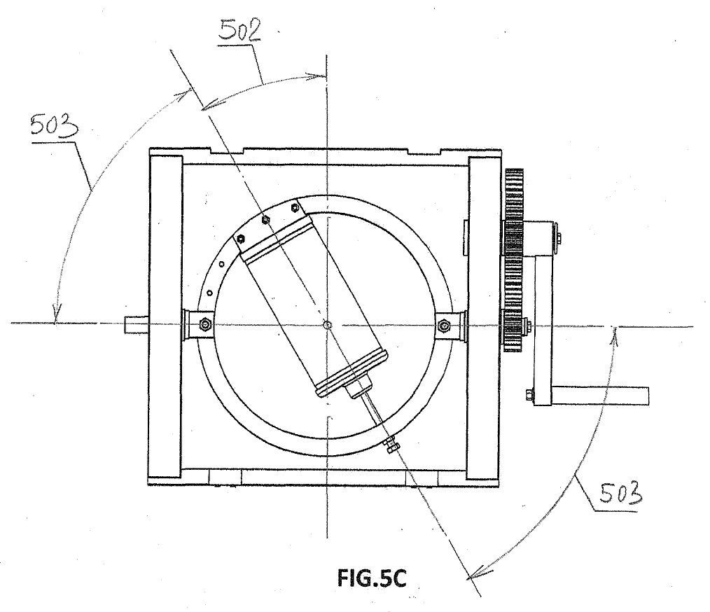

FIG. 5A,—on a figure the face-to-face projection of the device with a designation of all dimensional dependences between axes of shaft and critical points of the container with initial products for manufacture of a food composition is shown, at the bottom position of the mechanism of a clip and fixing of the container

By figures on a figure are designated:
501,—the center of symmetry of the three-dimensional system, received from conditional crossing a linear axis of the container with an axis of rotation of the container

FIG. 5B,—on a figure the face-to-face projection of the device with a designation of all dimensional dependences between axes of shaft and critical points of the container with initial products for manufacture of a food composition is shown, at the top position of the mechanism of a clip and fixing of the container

By figures on a figure are designated:
502,—a corner of an inclination of a linear axis of the container to a vertical axis of the device
503,—a corner of an inclination of a linear axis of the container to a horizontal axis of its rotation

FIG. 5C,—on a figure the face-to-face projection of the device with a designation of all dimensional dependences between axes of shaft and critical points of the container with initial products for manufacture of a food composition is shown, at the bottom position of the mechanism of a clip and fixing of the container

In some embodiments, a natural milk based food composition is provided, including a matrix, in which cavitation breaks contain capsulated fillers of compositions, and the matrix mainly includes dairy-sour fatty components which material is an environment of capsules fillers compositions, and in boundary layers between capsules and a matrix contains emulsion from base materials of fillers compositions in which materials of a matrix in the form of micro-droplets are introduced

In some embodiments, a natural milk based food composition is provided, including a spatial matrix, in which cavitation breaks contain capsulated fillers compositions, and the matrix mainly includes dairy-sour fatty components which material is also an environment of capsules of fillers compositions, and in boundary layers between capsules and a matrix contains emulsion from base materials of fillers compositions in which materials of a matrix in the form of micro-droplets, having the developed internal three-dimensional structure are introduced

In some embodiments, a natural milk based food composition is provided, including a matrix, in which cavitation breaks contain capsulated fillers of compositions, and the matrix mainly includes dairy-sour fatty components which material is an environment of capsules of fillers of compositions, and in boundary layers between capsules and a matrix contains emulsion from base materials of the fillers of compositions in which materials of a matrix and in which are introduced, insoluble in materials of fillers of compositions, materials of a matrix in the form of micro-droplets are dissolved

It will be appreciated by those skilled in the art that various omissions, additions and modifications may be made to the methods and structures described above without departing from the scope of the invention. All such modifications and changes are intended to fall within the scope of the invention, as defined by the appended claims.

1. (canceled)

2. (canceled)

3. (canceled)

4. A device for churning a butter composition out of a mass of multi-component raw material, said device comprising:
a) permanent parts and replaceable parts,
wherein said permanent parts comprise:
i. a frame having a rotation axis passing in a first direction of said frame, and
ii. a spindle for rotating said frame around said first axis;
wherein said replaceable parts comprise:
iii. hemispherical lids, said lids having conical recesses at their hemispherical tops and conical stubs at the opposite ends of said lids;
iv. a container casing with conical recesses at their butt-ends, said recesses receive said conical stubs, and
v. a set of elements for fastening and sealing a churning container, and
wherein said replaceable parts are arranged along a second axis oriented at an angle to the first axis.

5. The device according to claim 1, wherein said angle of the second axis with respect to the first axis is a variable angle.

6. The device according to claim 1, wherein said conical recesses at the tops of hemispherical lids receive the fastening and sealing elements.

7. The device according to claim 1, wherein said fastening and sealing elements have fluid and powder raw-material components supply and disposal channels communicating with the inner cavity of said container.

8. The device according to claim 1, wherein at least one of said fastening and sealing elements contains a ball valve said valve connects the inner cavity of said container with ambient.

9. A device for churning butter composition out of a mass of multi-component raw material, said device comprising:
permanent parts and replaceable parts kinematically interlinked by mechanisms performing rotational and reciprocal movement of the mass of a multi-component raw material and wherein the mounting axes of the permanent and replaceable parts are located at an angle with respect to one another.

10. The device according to claim 6, wherein the rotation axis of said permanent parts is located horizontally.

11. The device according to claim 6, wherein said permanent parts comprise:
a) a ring frame having a rotation axis passing in a first direction of said frame, and
b) a spindle for rotating said frame around said first axis.

12. The device according to claim 5, wherein said replaceable parts comprise:
a) a set of elements for fastening and sealing a churning container;
b) a churning container casing closed by hemispherical lids, said lids having conical recesses at their tops and conical apertures for receiving said fastening and sealing elements, and
wherein said replaceable parts are arranged along a second axis oriented at an angle to said first axis.

13. The device according to claim 5, wherein said angle of the second axis with respect to the first axis is a variable angle.

14. A device for churning butter composition out of multi-component raw material based on a lactate matrix with varying fat content parameters, said device comprising:
a) a collapsible and replaceable churning container mounted on a ring frame and having at least two points of fixation with respect to said ring frame, said container includes:
i. an axis passing through said two points;
ii. hemispherical lids having at the tops of their hemispheres, conical apertures and conical stubs at their opposite ends;
iii. a container casing having at their butt-ends conical recesses into which said conical stubs are inserted;
b) elements for fastening and sealing the container with hemispherical lids, said elements located at each of said points of fixation.
c) a rotation axis about which said container rotates, said axis being arranged at an angle to the axis passing through said fixation points.

15. The device according to claim 11, wherein said angle of the axis passing through said fixation points with respect to the rotation axis is a variable angle.

16. The device according to claim 11, wherein said means for fastening and sealing the container are inserted in the conical apertures of said hemispherical lids.

17. The device according to claim 11, wherein said fastening and sealing elements have fluid and powder raw-material, and waste components supply and disposal channels communicating with the inner cavity of said container.

18. The device according to claim 11, wherein at least one of the said elements contains a ball valve, which is connects, at a fixed position of the said element the inner cavity of the churning container with ambient.

19. The device according to claims 11 and 15, wherein said ball valve is an outlet for the churning waste removal.

20-37. (canceled)
